(19) United States
(12) Patent Application Publication
(10) Pub. No.: US 2014/0335713 A1
(43) Pub. Date: Nov. 13, 2014

(54) CONNECTOR

(71) Applicant: YAZAKI CORPORATION, Tokyo (JP)

(72) Inventors: Feng WANG, Shizuoka (JP); Ayumu ISHIKAWA, Shizuoka (JP)

(73) Assignee: YAZAKI CORPORATION, Tokyo (JP)

(21) Appl. No.: 14/269,381

(22) Filed: May 5, 2014

(30) Foreign Application Priority Data
May 7, 2013 (JP) 2013-097475

(51) Int. Cl. H01R 9/15

(52) U.S. Cl. CPC H01R 9/15
USPC 439/278

(57) ABSTRACT

A connector includes: an attachment wall portion provided with an attachment hole; a housing including an insertion portion to be inserted into the attachment hole and a fixed portion to be fixed to the attachment wall portion; a wire inserted into the insertion portion and including a wire end connected to a terminal; an attachment portion arranged on an opposite side of the fixed portion of the housing over the attachment wall portion, the attachment portion to be connected to the terminal through a fixing member under condition that the housing is fixed to the attachment wall portion through the fixed portion; and a detection portion arranged on the insertion portion, the detection portion for differentiating an insertion force in a case where inserting the insertion portion into the attachment hole and in a case where the insertion of the insertion portion into the attachment hole has been completed.

### CROSS REFERENCE TO RELATED APPLICATION

The present application is based on, and claims priority from, Japan Application Serial Number 2013-097475, filed May 7, 2013, the disclosure of which is hereby incorporated by reference herein in its entirety.

### BACKGROUND

1. Technical Field

The present invention relates to a connector.

2. Related Art

In a conventional example, there is known a connector including: an instrument serving as an attachment wall portion provided with an attachment hole; an inner housing and an outer housing by which serve as a housing including a peripheral wall as an insertion portion to be inserted into the attachment hole, and a flange portion as a fixed portion fixed to the instrument; a wire inserted into the inner circumferential side of the peripheral wall and having an end fixed to a terminal; and an attachment portion which is arranged on the opposite side of the flange portion of the housing over the instrument and to which the terminal is connected through a fixing member under condition that the housing is fixed to the instrument through the flange portion (refer to JP 2012-033348 A).

In the conventional connector, the housing is fixed to the instrument by inserting the peripheral wall of the housing into the attachment hole of the instrument and subsequently fixing the flange portion to the instrument through a bolt. In this state, the terminal is positioned on the attachment portion and therefore, the terminal is connected to the attachment portion through the fixing member, such as bolt.

### SUMMARY

In the conventional connector, if the insertion portion of the housing is inserted into the attachment hole of the attachment wall portion incompletely, then a clearance is produced between the fixed portion of the housing and the attachment wall portion. This clearance between the fixed portion and the attachment wall portion can be eliminated by such as bolting.

However, in a situation where contaminants, such as dust, invade the clearance produced between the fixed portion and the attachment wall portion, there still remains the clearance between the fixed portion and the attachment wall portion despite the above measure of fixing the fixed portion to the attachment wall portion.

If the clearance is produced between the fixed portion and the attachment wall portion in the above way, the position of an attachment portion on the opposite side of the attachment wall portion is displaced from the position of the terminal, so that the terminal and the attachment portion could not be connected to each other through the fixing member.

Therefore, an object of the present invention is to provide a connector which can prevent such an incomplete insertion of an insertion portion of a housing into an attachment hole of an attachment wall portion and also such a positional displacement between a terminal and the attachment portion.

A connector according to an aspect of the present invention includes: an attachment wall portion provided with an attachment hole; a housing including an insertion portion to be inserted into the attachment hole, and a fixed portion to be fixed to the attachment wall portion; a wire inserted into the insertion portion and including a wire end connected to a terminal; an attachment portion arranged on an opposite side of the fixed portion of the housing over the attachment wall portion, attachment portion to be connected to the terminal through a fixing member under condition that the housing is fixed to the attachment wall portion through the fixed portion; and a detection portion arranged on one of the attachment hole and the insertion portion, the detection portion for differentiating an insertion force in a case where inserting the insertion portion into the attachment hole and in a case where the insertion of the insertion portion into the attachment hole has been completed.

As the detection portion is arranged on one of the attachment hole and the insertion portion to differentiate the insertion force in the case where inserting the insertion portion into the attachment hole and in the case where the insertion of the insertion portion into the attachment hole has been completed, an operator can feel the insertion state of the insertion portion owing to the change in the insertion force of the insertion portion into the attachment hole by the detection portion. As a result, it is possible to prevent the insertion portion from being inserted into the attachment hole incompletely.

Therefore, since no clearance is produced between the fixed portion of the housing and the attachment wall portion, the positional displacement between the attachment portion on the opposite side of the attachment wall portion and the terminal is prevented to enable the terminal to be connected to the attachment portion through the fixing member certainly.

In such a connector, therefore, it is possible to prevent such an incomplete insertion of the insertion portion into the attachment hole and also possible to prevent such a positional displacement between the terminal and the attachment portion.

The detection portion may include a flexible portion flexibly arranged on one of the attachment hole and the insertion portion. In this case, the flexible portion is adapted so as to bend while sliding on the other of the attachment hole and the insertion portion when the insertion portion is inserted into the attachment hole, and the bending of the flexible portion is released when the fixed portion of the housing is positioned at an attachment position of the attachment wall portion.

As the detection portion includes the flexible portion which is bent while sliding on the attachment hole when the insertion portion is inserted into the attachment hole and of which bending is released when the fixed portion of the housing is positioned at the attachment position on the attachment wall portion, it is possible to apply a variation on the insertion force of the insertion portion into the attachment hole due to the bending of the flexible portion and the release of the bending.

The flexible portion may be arranged in the insertion portion. Then, the flexible portion is provided with a projection which slides on an inner wall of the attachment hole when the insertion portion is inserted into the attachment hole, and the attachment hole is provided with a cancel portion which releases the sliding with the projection when the fixed portion of the housing is positioned at the attachment position in the attachment wall portion.

As the flexible portion of the insertion portion is provided with the projection which slides on the inner wall of the attachment hole when the insertion portion is inserted into the attachment hole, while the attachment hole is provided with the cancel portion which releases the sliding of the projection when the fixed portion of the housing is located at the attachment position on the attachment wall portion, the bending of the flexible portion and the releasing of bending can be accomplished by the sliding of the projection on the inner wall of the attachment hole and the cancelling of such sliding.

The cancel portion may be a recess portion which is arranged on the inner wall of the attachment hole and in which the projection is accommodated when the fixed portion of the housing is positioned at the attachment position in the attachment wall portion.

As the cancel portion is the recess which is formed on the inner wall of the attachment hole and in which the projection is accommodated when the fixed portion of the housing is located at the attachment position on the attachment wall portion, it is possible to allow the projection to be accommodated in the recess under the condition that the fixed portion of the housing is located at the attachment position on the attachment wall portion and also possible to release the bending of the flexible portion even when the attachment hole is formed long or the flexible portion is formed short.

The projection may be provided with an extraction portion which bends the flexible portion to allow the projection to slide on the inner wall of the attachment hole when the insertion portion is extracted from the attachment hole.

As the projection is provided with the extraction portion which bends the flexible portion to allow the projection to slide on the inner wall of the attachment hole when the insertion portion is extracted from the attachment hole, it is possible to detach the housing from the attachment wall with ease, under condition that the fixing of the fixed portion of the housing with the attachment wall portion is cancelled.

In accordance with the aspect of the present invention, it is possible to produce an effect of providing the connector by which it is possible to prevent such an incomplete insertion of the insertion portion of the housing into the attachment hole of the attachment wall portion and also possible to prevent such a positional displacement between the terminal and the attachment portion.

### BRIEF DESCRIPTION OF DRAWINGS

FIG. 1 is an exploded perspective view of a connector according to a first embodiment.

FIG. 2 is a sectional view illustrating a situation in a process of assembling a housing of the connector according to the first embodiment to an attachment wall portion.

FIG. 3 is a sectional view illustrating a situation where the assembling of the housing of the connector according to the first embodiment to the attachment wall portion has been completed.

FIG. 4 is a sectional view illustrating a situation where the assembling of the housing of the connector according to a second embodiment to the attachment wall portion has been completed.

### DETAILED DESCRIPTION

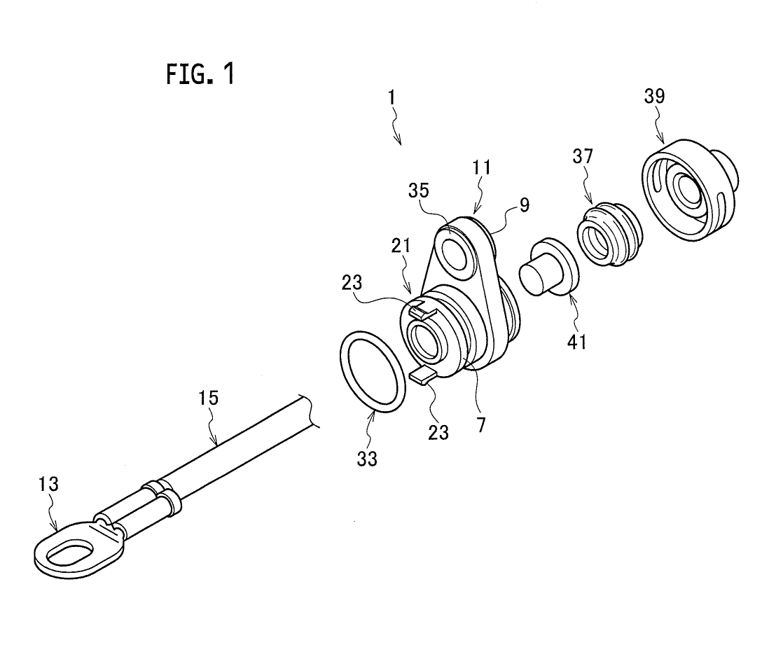

Connectors according to embodiments of the present invention will be described with reference to FIGS. 1 to 4.

### First Embodiment

A first embodiment will be described with reference to FIGS. 1 to 3.

A connector 1 according to the first embodiment includes an attachment wall portion 5 provided with an attachment hole 3, a housing 11 including an insertion portion 7 to be inserted into the attachment hole 3 and a fixed portion 9 to be fixed with the attachment wall portion 5, a wire 15 inserted into the insertion portion 7 and having its end connected to a terminal 13, and an attachment portion 19 which is arranged on the opposite side of the fixed portion 9 of the housing 11 over the attachment wall portion 5 and to which the terminal 13 is connected through a fixing member 17 under condition that the housing 11 is fixed to the attachment wall portion 5 through the fixed portion 9.

In the housing 11, the insertion portion 7 is provided with a detection portion 21 which differentiates an insertion force in a case of inserting the insertion portion 7 into the attachment hole 3 and in a case where the insertion of the insertion portion 7 into the attachment hole 3 has been completed.

The detection portion 21 includes a flexible portion 23 flexibly provided in the insertion portion 7. When the insertion portion 7 is inserted into the attachment hole 3, the flexible portion 23 bends while sliding on the attachment hole 3. The bending of the flexible portion 23 is released when the fixed portion 9 of the housing 11 is positioned at a predetermined attachment position of the attachment wall portion 5.

The flexible portion 23 is provided with a projection 27 which slides on an inner wall of the attachment hole 3 when the insertion portion 7 is inserted into the attachment hole 3. The attachment hole 3 is provided with a cancel portion 25 which releases the sliding with the projection 27 when the fixed portion 9 of the housing 11 is positioned at the attachment position in the attachment wall portion 5.

The projection 27 is provided with an extraction portion 29 which bends the flexible portion 23 to allow the projection 27 to slide on the inner wall of the attachment hole 3 when the insertion portion 7 is extracted from the attachment hole 3.

The attachment wall portion 5 is arranged in a sidewall of a casing which houses an instrument or the like. In the attachment wall portion 5, the attachment hole 3 is arranged to penetrate through an interior and exterior of the casing. The attachment hole 3 is circular-shaped so as to allow an insertion of the insertion portion 7 of the housing 11. In the attachment hole 3, its opening edge on the side of the housing 11 is formed in a tapered shape. When the insertion portion 7 of the housing 11 is inserted into the attachment hole 3, the casing is closed.

The housing 11 is made from insulating synthetic resin material and includes the insertion portion 7, the fixed portion 9, and an insertion hole 31. The insertion portion 7 is cylindrical-shaped so as to extend from its base portion toward the attachment wall portion 5. The insertion portion 7 has its diameter equal to or somewhat smaller than an inner diameter of the attachment hole 3. An O-ring 33 as a sealing member is tightly accommodated in a groove portion on a periphery of the insertion portion 7. Under condition that the insertion portion 7 is inserted into the attachment hole 3, the O-ring 33 adheres tightly to the inner wall of the attachment hole 3 and a peripheral face of the insertion portion 7, to seal between the insertion portion 7 and the attachment hole 3.

When the housing 11 is assembled to the attachment wall portion 5, the insertion portion 7 is inserted into the attachment hole 3 of the attachment wall portion 5. Such an inserting state of the insertion portion 7 into the attachment hole 3 is maintained by fixing the fixed portion 9 to the attachment wall portion 5 under condition that the insertion portion 7 is inserted into the attachment hole 3 completely.

The fixed portion 9 is triangular-shaped so as to extend from its base part toward one side in the radial direction and also provided, at a center thereof, with a hole fitted with a collar 35. When the insertion portion 7 is inserted into the attachment hole 3 completely, a lateral wall face of the fixed portion 9 is brought into contact with the attachment wall portion 5, so that the collar 35 is aligned with a bolt hole of the attachment wall portion 5. In this state, the fixed portion 9 is fixed to the attachment wall portion 5 through a fixing member (not illustrated), such as a bolt. An insertion hole 31 is arranged on a housing's base part provided with the fixed portion 9. Note, the fixing of the fixed portion 9 to the attachment wall portion 5 is not limited to only such a connection by bolting and therefore, the fixed portion 9 may be fixed to the attachment wall portion 5 by such as adhesive.

The insertion hole 31 Penetrates through a central portion of the base part, and is communicated with the insertion portion 7. Inserted into the insertion hole 31 is the wire 15 which is connected to a power supply, instruments, or the like. With the use of technique of crimping or the like, a terminal 13 is electrically connected with an end of the wire 15. The terminal 13 has a connecting portion provided with a hole allowing an insertion of the fixing member 17, such as a bolt, therethrough.

A seal member 37 made from elastic material, such as synthetic rubber, is arranged on a periphery of the wire 15. The seal member 37 adheres tightly to the inner wall of the insertion hole 31 and a peripheral face of the wire 15 to seal between the housing 11 and the wire 15.

On the insertion hole's (31) side of extracting the wire 15, a rear holder 39 is assembled to the housing 11 to close the insertion hole 31. Another seal member may be arranged between the insertion hole 31 and the rear holder 39 to seal between housing 11 and the rear holder 39. On the seal member's (37) side closer to the insertion portion 7, there is a housing stopper 41 which is press fitted to the wire 15 to suppress the movement of the housing 11 relative to the wire 15.

The terminal 13, which is arranged at the end of the wire 15 inserted into the insertion hole 31, is made from conductive material and extracted from the insertion portion 7 to the exterior of the housing 11. When the housing 11 is assembled to the attachment wall portion 5, the terminal 13 is located in a position corresponding to the attachment portion 19.

The attachment portion 19 is made from conductive material and connected to an instrument or the like electrically. The attachment portion 19 is formed with a hole into which the fixing member 17 is tightened up. Provided that this hole is aligned with the terminal 13, the attachment portion 19 is electrically connected to the terminal 13 through the fixing member 17.

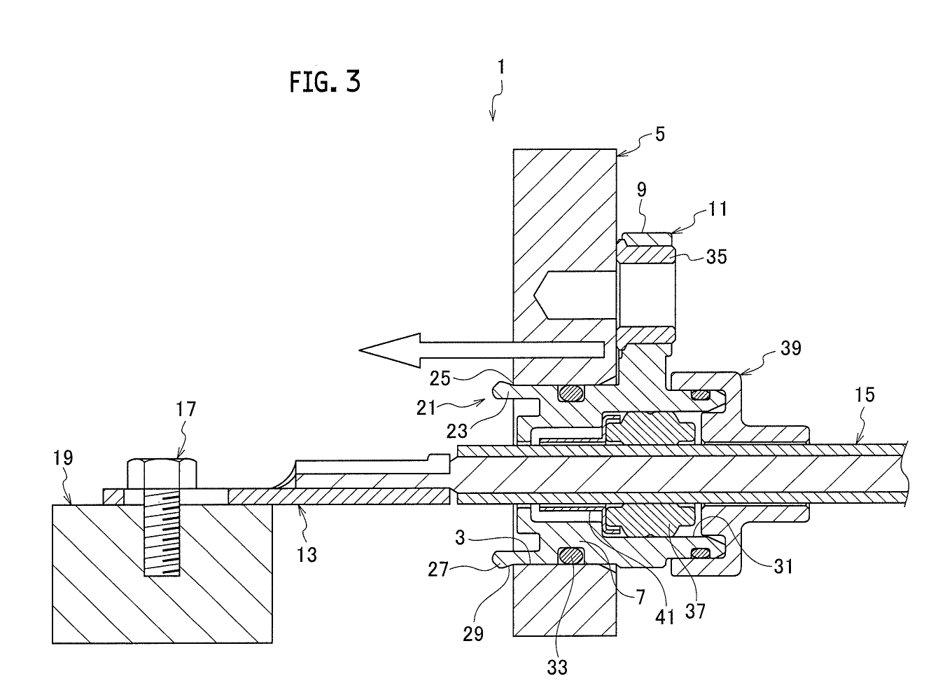

In the connector 1 constructed above, when the insertion portion 7 of the housing 11 is inserted into the attachment hole 3 of the attachment wall portion 5 completely, there is produced no clearance between the fixed portion 9 of the housing 11 and the attachment wall portion 5. In this state, as illustrated in FIG. 3, the terminal 13 is arranged on the attachment portion 19 so as to enable the fixing member 17 to be inserted into both the terminal 13 and the attachment portion 19.

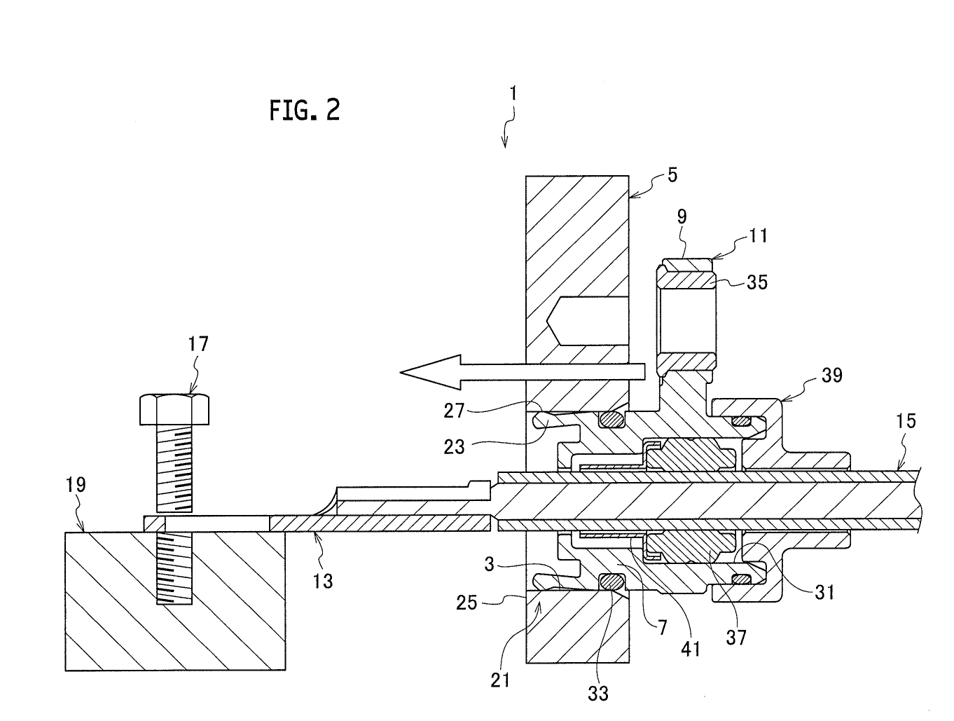

In the connector 1, when the insertion portion 7 of the housing 11 is inserted into the attachment hole 3 of the attachment wall 5 incompletely, there is produced the clearance between the fixed portion 9 of the housing 11 and the attachment wall portion 5. In this state, as illustrated in FIG. 2, there is produced a positional displacement between the terminal 13 and the attachment portion 19, so that the fixing member 17 cannot be inserted into both the terminal 13 and the attachment portion 19 since the terminal 13 interferes with the fixing member 17.

In order to prevent the insertion portion 7 of the housing 11 from being inserted into the attachment hole 3 of the attachment wall portion 5 incompletely, the insertion portion 7 of the housing 11 is provided with the detection portion 21 which varies an insertion force required to insert the insertion portion 7 into the attachment hole 3.

The detection portion 21 includes flexible portions 23 flexibly arranged, on the side of a leading end of the insertion portion 7, at two positions at regular intervals in the circumferential direction. Each of the flexible portions 23, which is a single member continuous to the insertion portion 7, is formed so as to extend toward the inserting direction into the attachment hole 3, providing a thin cantilever having a rear anchor of the end face of the insertion portion 7. On the peripheral face of each of the flexible portions 23 on the side of its free end, a projection 27 is formed so as to project radially outward over the outer diameter of the insertion portion 7, so that the projection 27 can be located on the lateral face of the cancel portion 25 at the opening edge of the attachment hole 3. The number of places for the flexible portions 23 may be more than two or only one.

The flexible portions 23 are bent radially inward of the insertion portion 7 since the projections 27 slide on the inner wall of the attachment hole 3 under the condition that the insertion portion 7 is inserted into the attachment hole 3, as illustrated with arrow of FIG. 2. Then, the insertion force of the insertion portion 7 into the attachment hole 3 is equivalent to a frictional resistance where the sliding of the projections 27 on the inner wall of the attachment hole 3 is combined with the sliding of the O-ring 33 on the inner wall of the attachment hole 3.

On the other hand, under the condition that the insertion portion 7 is inserted into the attachment hole 3 completely as illustrated with arrow of FIG. 3, in other words, when the fixed portion 9 of the housing 11 is located in the attachment position on the attachment wall portion 5, the projections 27 are positioned on the lateral face of the cancel portion 25. Consequently, the sliding of the projections 27 on the inner wall of the attachment hole 3 is cancelled to release the bending of the flexible portions 23. Then, the insertion force of the insertion portion 7 into the attachment hole 3 is equivalent to a frictional resistance resulting from only the sliding of the O-ring 33 on the inner wall of the attachment hole 3.

By changing the insertion force of the insertion portion 7 into the attachment hole 3 through the detection portion 21, it is possible to feel the insertion state of the insertion portion 7 into the attachment hole 3. Thus, it is possible to prevent an incomplete insertion of the insertion portion 7 into the attachment hole 3. As a result, there is no possibility that a clearance is produced between the fixed portion 9 of the housing 11 and the attachment wall portion 5 to cause an interposition of contaminants between the fixed portion 9 and the attachment wall portion 5.

The projection 27 is provided with the extraction portion 29 which bends the flexible portion 23 to allow the projection 27 to slide on the inner wall of the attachment hole 3 when the insertion portion 7 is extracted from the attachment hole 3. This extraction portion 29 is formed by an inclined face which is inclined downward toward a direction to extract the insertion portion 7 from the attachment hole 3. By cancelling the fixing of the fixed portion 9 of the housing 11 with the attachment wall portion 5 and further extracting the insertion portion 7 from the attachment hole 3, the resulting contact of the extraction portions 20 with the cancel portion 24 causes the flexible portions 23 to be bent to allow the projections 7 to slide on the inner wall of the attachment hole 3. In this way, the housing 11 can be detached from the attachment wall portion 5 with ease.

Thus, in the connector 1, the insertion portion 7 of the housing 11 is provided with the detection portion 21 which differentiates the insertion force in the case of inserting the insertion portion 7 into the attachment hole 3 and in the case where the insertion of the insertion portion 7 into the attachment hole 3 has been completed. Owing to the change in the insertion force of the insertion portion 7 into the attachment hole 3 by the detection portion 21, an operator can feel the insertion state of the insertion portion 7. Consequently, it is possible to prevent the insertion portion 7 of the housing 11 from being inserted into the attachment hole 3 of the attachment wall portion 5 incompletely.

Therefore, since no clearance is produced between the fixed portion 9 of the housing 11 and the attachment wall portion 5, the positional displacement between the attachment portion 19 on the opposite side of the attachment wall portion 5 and the terminal 13 is prevented to enable the terminal 13 to be connected to the attachment portion 19 through the fixing member 17 certainly.

In the connector 1 mentioned above, therefore, it is possible to prevent such an incomplete insertion of the insertion portion 7 of the housing 11 into the attachment hole 3 of the attachment wall portion 5 and also possible to prevent such a positional displacement between the terminal 12 and the attachment portion 19.

Again, the detection portion 21 includes the flexible portions 23, each of the flexible portion 23 is bent while sliding on the attachment hole 3 when the insertion portion 7 is inserted into the attachment hole 3, and bending of each of the flexible portion 23 is released when the fixed portion 9 of the housing 11 is positioned at the attachment position on the attachment wall portion 5. Thus, it is possible to apply a variation on the insertion force of the insertion portion 7 into the attachment hole 3 due to the bending of the flexible portion 23 and the release of the bending.

Additionally, each of the flexible portions 23 is provided with the projection 27 which slides on the inner wall of the attachment hole 3 when the insertion portion 7 is inserted into the attachment hole 3, while the attachment hole 3 is provided with the cancel portion 25 which releases the sliding of the projection 27 when the fixed portion 9 of the housing 11 is located at the attachment position on the attachment wall portion 5. Thus, the bending of the flexible portions 23 and the releasing of the bending can be accomplished by the sliding of each projection 27 on the inner wall of the attachment hole 3 and the cancelling of such sliding.

Still further, the projection 27 is provided with the extraction portion 29 which bends the flexible portions 23 to allow the projection 27 to slide on the inner wall of the attachment hole 3 when the insertion portion 7 is extracted from the attachment hole 3. Thus, under condition that the fixing of the fixed portion 9 of the housing 11 with the attachment wall portion 5 is cancelled, it is possible to detach the housing 11 from the attachment wall portion 5 with ease.

### Second Embodiment

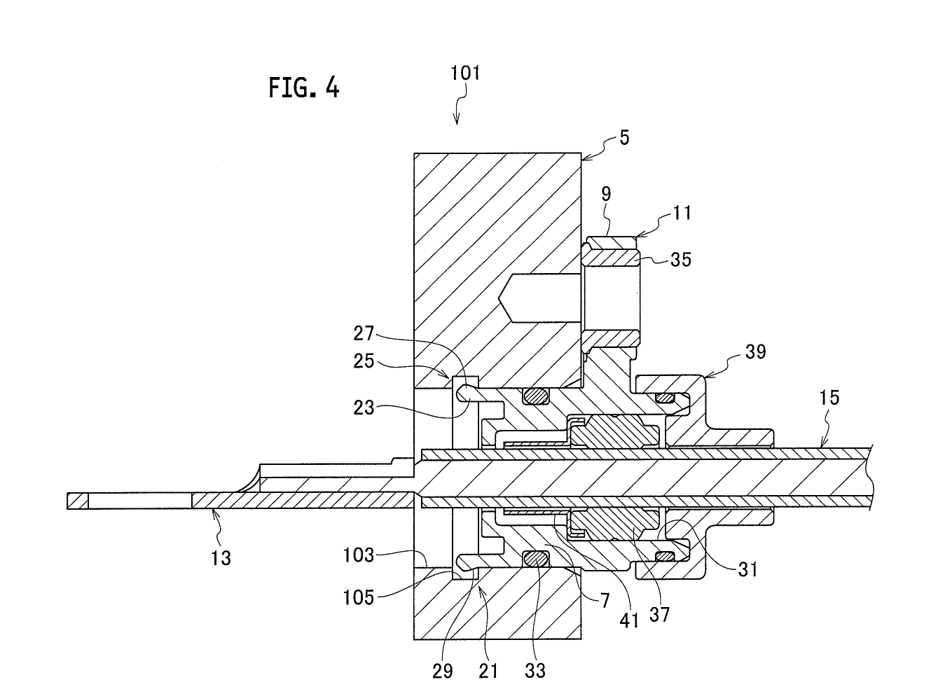

A second embodiment will be described with reference to FIG. 4.

In a connector 101 according to the second embodiment, the cancel portion 25 is a recess 105 which is arranged in an inner wall of an attachment hole 103 and in which the projection 27 is accommodated when the fixed portion 9 of the housing 11 is located at the attachment position on the attachment wall portion 5.

Note, in the second embodiment, elements identical to those of the first embodiment are indicated with the same reference numerals and therefore, their explanations are omitted. Because of its identity with the first embodiment, the explanations of its constitution and function are also omitted with reference to the first embodiment. Nevertheless, it is noted that effects afforded by the second embodiment are identical to those by the first embodiment.

As illustrated in FIG. 4, the cancel portion 25 in the attachment hole 103 is the recess 105 in the form of a circumferential groove on the inner wall of the attachment hole 103. Under a condition that the insertion portion 7 is inserted into the attachment hole 103 completely, in other words, the fixed portion 9 of the housing 11 is located at the attachment position on the attachment wall portion 5, the sliding of the projections 27 on the inner wall of the attachment hole 103 is cancelled and the bending of the flexible portions 23 is released since the projections 27 are accommodated in the recess 105.

The recess 105 as the cancel portion 25 for releasing of bending the flexible portions 23 is provided with the inner wall of the attachment hole 103. Accordingly, even when a length of the attachment hole 103 is longer than the attachment hole 3 of the first embodiment, the flexible portions 23 can be bending and released without changing a length of each of the flexible portions 23.

In the connector 101, the cancel portion 25 is the recess 105 which is formed on the inner wall of the attachment hole 103 and in which the projections 27 are accommodated when the fixed portion 9 of the housing 11 is located at the attachment position on the attachment wall portion 5. Accordingly, even when the attachment hole 103 is formed long or the flexible portions 23 are formed short, it is possible to allow the projections 27 to be accommodated in the recess 105 under condition that the fixed portion 9 of the housing 11 is located at the attachment position on the attachment wall portion 5 and also possible to release the bending of the flexible portions 23.

Although the flexible portions 23 are provided in the insertion portion 7 of the housing 11 in common with the above-mentioned embodiments, the position of the flexible portions 23 is not limited to this arrangement. For example, the flexible portions 23 may be arranged in an opening edge of the attachment hole of the attachment wall portion 5.

Further, although the insertion portion 7 is cylindrical-shaped, the shape of the insertion portion 7 has only to be established so as to accord with the shape of the attachment hole of the attachment wall portion 5.

Further, without being limited to the flexible portions 23, any form of the detection portion 21 is applicable, as long as it can change an insertion force of the insertion portion corresponding to the situation of the insertion portion inserted into the attachment hole. For example, the inner wall of the attachment hole may be provided with projections which can slide on the periphery of the insertion portion, provided that a recess, which can accommodate the projections under condition that the fixed portion of the housing is located at the attachment position on the attachment wall portion, is formed on the periphery of the insertion portion.

Additionally, although the cancel portion 25 is constructed so as to release the bending of the flexible portions 23 since the projection 27 of each of the flexible portions 23 is either positioned on the lateral face of the attachment wall portion 5 (in the first embodiment) or accommodated in the recess 105 (in the second embodiment), the arrangement may be modified so that the projection 27 is engaged with the cancel portion 25 when the fixed portion 9 of the housing 11 is located at the attachment position on the attachment wall portion 5. In such a case, the housing 11 could be fixed to the attachment wall portion 5 temporarily before the fixed portion 9 of the housing 11 is fixed to the attachment wall portion 5.

Still further, although the recess 105 as the cancel portion 25 is provided in the form of the circumferential groove on the inner wall of the attachment hole 103 in the connector 101 according to the second embodiment, any configuration of the recess 105 is applicable, as long as it can accommodate each projection 27 when the fixed portion 9 of the housing 11 is located at the attachment position on the attachment wall portion 5.

What is claimed is:

1. A connector, comprising:
an attachment wall portion provided with an attachment hole;
a housing comprising an insertion portion to be inserted into the attachment hole, and a fixed portion to be fixed to the attachment wall portion;
a wire inserted into the insertion portion and comprisng a wire end connected to a terminal;
an attachment portion arranged on an opposite side of the fixed portion of the housing over the attachment wall portion, the attachment portion to be connected the terminal through a fixing member under condition that the housing is fixed to the attachment wall portion through the fixed portion; and
a detection portion arranged on one of the attachment hole and the insertion portion, the detection portion for differentiating an insertion force in a case where inserting the insertion portion into the attachment hole and in a case where the insertion of the insertion portion into the attachment hole has been completed.

2. The connector according to claim 1, wherein
the detection portion comprises a flexible portion flexibly arranged on one of the attachment hole and the insertion portion,
the flexible portion is adapted so as to bend while sliding on the other of the attachment hole and the insertion portion when the insertion portion is inserted into the attachment hole, and
the bending of the flexible portion is released when the fixed portion of the housing is positioned at an attachment position of the attachment wall portion.

3. The connector according to claim 2, wherein
the flexible portion is arranged in the insertion portion,
the flexible portion is provided with a projection which slides on an inner wall of the attachment hole when the insertion portion is inserted into the attachment hole, and
the attachment hole is provided with a cancel portion which releases the sliding with the projection when the fixed portion of the housing is positioned at the attachment position in the attachment wall portion.

4. The connector according to claim 3, wherein
the cancel portion is a recess portion which is arranged on the inner wall of the attachment hole and in which the projection is accommodated when the fixed portion of the housing is positioned at the attachment position in the attachment wall portion.

5. The connector according to claim 3, wherein
the projection is provided with an extraction portion which bends the flexible portion to allow the projection to slide on the inner wall of the attachment hole when the insertion portion is extracted from the attachment hole.

6. The connector according to claim 4, wherein
the projection is provided with an extraction portion which bends the flexible portion to allow the projection to slide on the inner wall of the attachment hole when the insertion portion is extracted from the attachment hole.
